(19) United States
(12) Patent Application Publication
(10) Pub. No.: US 2016/0001713 A1
(43) Pub. Date: Jan. 7, 2016

(54) CAMERA DEVICE

(71) Applicant: Yuhua WANG, Beijing (CN)

(72) Inventor: Yuhua WANG, Beijing (CN)

(21) Appl. No.: 14/760,202

(22) PCT Filed: Jan. 22, 2014
(86) PCT No.: PCT/CN2014/071069

§ 371 Date: Jul. 9, 2015

(30) Foreign Application Priority Data
Jan. 24, 2013 (CN) 201320036202.2

(51) Int. Cl. B60R 11/04; H04N 7/18

(52) U.S. Cl. CPC B60R 11/04; H04N 7/183; B60R 2011/004

(57) ABSTRACT

A camera device (1) for an automobile backing-up video assembly is disclosed. The device (1) comprises a base (10) and a camera box (11) attached to the base (10) and having a camera (12). The installation on the rear of the automobile is conducted as follows: arranging an electrical plug (17) on the base (10) to allow the electrical plug (17) to fit into an electrical socket at the rear of the automobile, thus completing the installation and fixation, and then connecting a power supply; alternatively, arranging on the base (10) a magnet capable of being attracted to the metal of the iron family, such that the entire device is firmly attached to the iron surface of the automobile shell via the magnetic force.

### FIELD OF THE INVENTION

The present invention relates to a camera device employed in an automobile backing-up video assembly. The automobile backing-up video assembly is used to provide a clear position indication for a driver when an automobile is backed up or parked. The camera device is used to provide information of a video or image behind the automobile.

### BACKGROUND OF THE INVENTION

In the prior art, a technical solution in which a camera device is conveniently mounted to a tail portion of an automobile has not been provided.

### SUMMARY OF THE INVENTION

A general object of the present invention is to provide a technical solution to overcome the disadvantage in the prior art.

An object of the present invention is to provide a camera device, the camera device includes a base and a camera box attached to the base, the camera device is adapted to be mounted outside a tail portion of an automobile so that a camera in the camera box faces rearward of the automobile, the base has a U-shaped space, a distance between two sides of the U-shape is approximately equal to a length of the camera box so that the camera box is exactly laid within the U-shaped space, pivot and bearing structures which enable the camera box to be rotated by an angle with respect to the U-shaped space of the base are provided at positions where each of both ends of the camera box adjoins to or connects with the U-shaped space, and an electrical plug which is matchable with an electrical socket in the tail portion of the automobile so as to be connected to a power supply is provided integrally with the base.

A fixing catch which matches with a spring closing cap of the electrical socket in the tail portion of the automobile is provided on the base.

A lock engaging ring to be connected to a theftproof lock is provided in the base.

Semiconductor auxiliary light sources with the number of 2 to 12 are provided around the camera of the camera box.

A pair of supersonic range alerting probes are provided on both sides of the camera box on the base.

Another object of the present invention is to further provide a camera device, the camera device includes a base and a camera box attached to the base, the camera device is adapted to be mounted outside a tail portion of an automobile so that a camera in the camera box faces rearward of the automobile, the base has a U-shaped space, a distance between two sides of the U-shape is approximately equal to a length of the camera box so that the camera box is exactly laid within the U-shaped space, pivot and bearing structures which enable the camera box to be rotated by an angle with respect to the U-shaped space of the base are provided at positions where each of both ends of the camera box adjoins to or connects with the U-shaped space, a battery bin for storing a battery as a power supply is provided in the base, and a magnet which is magnetically attachable on metal of iron family is provided to a surface of the base.

A power supply lead is led out from the base, and an electrical plug which is matchable with an electrical socket in the tail portion of the automobile is provided on a distal end of the power supply lead.

A lock engaging ring to be connected to a theftproof lock is provided in the base.

Semiconductor auxiliary light sources with the number of 2 to 12 are provided around the camera of the camera box.

A pair of supersonic range alerting probes are provided on both sides of the camera box on the base.

Another object of the present invention is to further provide a camera device, the camera device includes a base and a camera box attached to the base, the camera device is adapted to be mounted outside a tail portion of an automobile so that a camera in the camera box faces rearward of the automobile, the base is divided into an electrical plug portion and a camera portion which are connectable to and separatable from each other, two pair of protruding tab-recessing groove structures which are connectable to and separatable from each other are provided in the electrical plug portion and the camera portion respectively, and a pair of electric contacts which are connectable to each other are provided at respective positions of each pair of the protruding tab-recessing groove structures, an electrical plug which is matchable with an electrical socket in the tail portion of the automobile so as to be connected to a power supply is provided integrally with the electrical plug portion of the base, a battery bin for storing a battery as a power supply is provided in the camera portion of the base, the base has a U-shaped space, a distance between two sides of the U-shape is approximately equal to a length of the camera box so that the camera box is exactly laid within the U-shaped space, pivot and bearing structures which enable the camera box to be rotated by an angle with respect to the U-shaped space of the base are provided at positions where each of both ends of the camera box adjoins to or connects with the U-shaped space, an electrical plug device which can be inserted into an electrical socket for a power supply of 12V-24V DC in the automobile so as to be connected to the power supply is additionally provided, the electrical plug device has a recessing groove-protruding tab structure which is matchable with the protruding tab-recessing groove structure of the camera portion of the base, and connectable electric contacts are provided in the recessing groove-protruding tab structure.

A magnet which is magnetically attachable on metal of iron family is also provided to a surface of the camera portion of the base.

A fixing catch which matches with a spring closing cap of the electrical socket in the tail portion of the automobile is provided on the electrical plug portion of the base.

A lock engaging ring to be connected to a theftproof lock is provided in the base.

Semiconductor auxiliary light sources with the number of 2 to 12 are provided around the camera of the camera box.

A pair of supersonic range alerting probes are provided on both sides of the camera box on the base.

### BRIEF DESCRIPTION OF THE DRAWINGS

FIGS. 1-A, 1-B and 1-C are views showing a camera device according to a first embodiment of the present invention, where FIG. 1-A is a front view of the camera device, FIG. 1-B is a front perspective view, and FIG. 1-C is a rear perspective view.

FIGS. 2-A, 2-B and 2-C are views showing a camera device according to a second embodiment of the present invention, where FIG. 2-A is a front perspective view of the camera device, FIG. 2-B is a top view, and FIG. 2-C is a rear view.

FIGS. 3-A, 3-B and 3-C are views showing a camera device according to a third embodiment of the present invention, where FIG. 3-A is a front perspective view of the camera device, FIG. 3-B is a top view, and FIG. 3-C is a rear view.

FIG. 4 is a view showing a camera device according to a fourth embodiment of the present invention.

FIGS. 5-A, 5-B and 6 are views showing a camera device according to a fifth embodiment of the present invention.

### DETAILED DESCRIPTION OF THE PREFERRED EMBODIMENTS

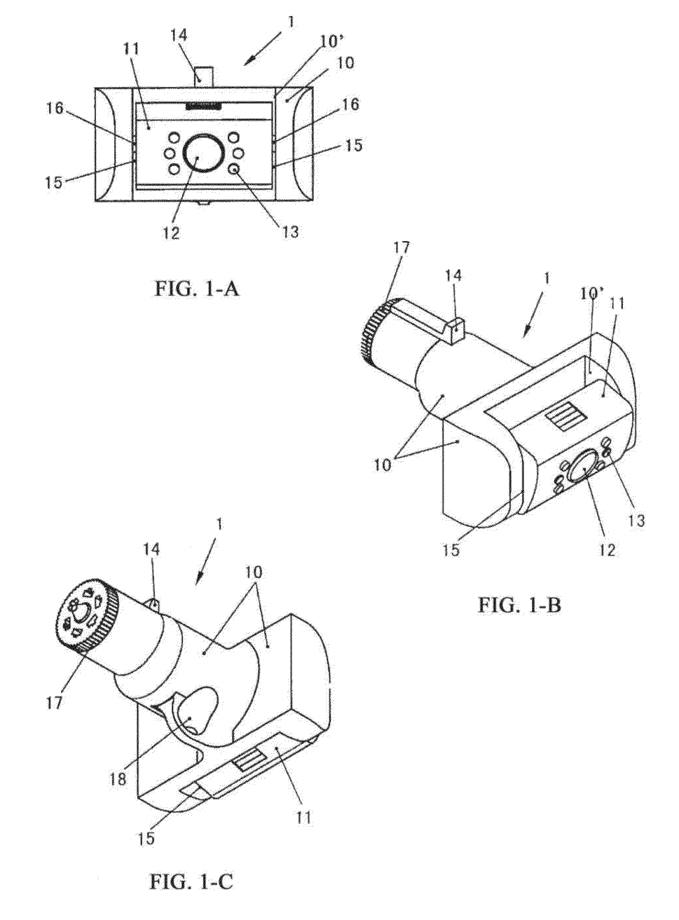

FIG. 1-A is a front view of a camera device 1 according to a first embodiment of the present invention. The camera device 1 includes a base 10 and a camera box 11. The camera box 11 has a camera 12 and semiconductor auxiliary light sources 13 with the number of 2 to 12 (for example, 6 in FIG. 1-A) which are located around the camera 12, and the semiconductor auxiliary light sources 13 are used to provide auxiliary illumination for the camera 12 in the dark. The base 10 and the camera box 11 are sized so that the camera box 11 can be put within a U-shaped space 10′ of the base 10 with a slight gap 15 left therebetween. In addition, pivot and bearing structures 16 are provided to the base 10 and the camera box 11 respectively so that the camera box 11 can be rotated by an angle (angle of depression or elevation) with respect to the U-shaped space 10′ of the base 10 to aim at a target to be picked up. The pivot and bearing structures 16 may be any common structure (not shown in FIG. 1-A).

FIG. 1-B is a front perspective view of the camera device 1. A rearward extending portion other than the U-shaped portion 10′ of the base 10 can be seen from FIG. 1-B, and an electrical plug 17 to be connected to a power supply is provided on a tip end of the rearward extending portion. The electrical plug 17 is constructed to match with a common electrical socket in a tail portion of an automobile (for example, a cross-country truck, a pickup truck and the like). When the electrical plug 17 is inserted into the electrical socket in the tail portion of the automobile and connected to the power supply, the camera device 1 is mounted and secured in a working position. The electrical socket in the tail portion of the automobile usually has a spring closing cap (not shown in FIG. 1-B). When the electrical plug 17 is inserted into the electrical socket in the tail portion of the automobile, the spring closing cap is firmly caught on a fixing catch 14 of the base 10 due to a resilient force of the spring closing cap so that the camera device 1 does not fall off as a result of travelling vibration of the automobile. As a matter of course, the shape and the position of the fixing catch 14 must perfectly match with those of the spring closing cap. Other reference numerals in FIG. 1-B are the same as those described above.

FIG. 1-C is a rear perspective view of the camera device 1. It can be seen that a lock engaging ring 18 to be connected to a theftproof lock is provided in a lower portion of the base 10. For example, the camera device 1 can be connected to a body of the automobile through the theftproof lock or a theftproof chain by use of the lock engaging ring 18 to avoid being stolen. Other reference numerals in FIG. 1-C are the same as those described above.

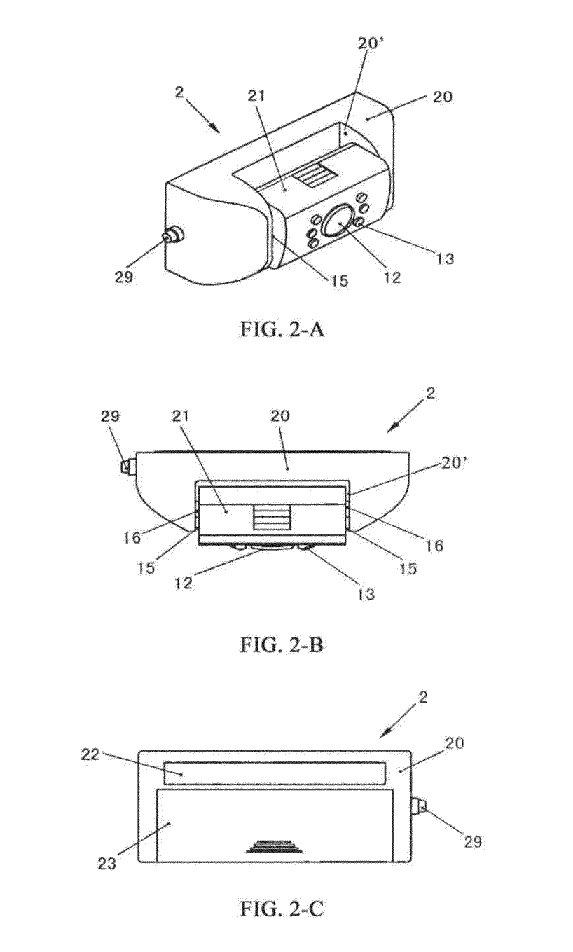

FIG. 2-A is a front perspective view of a camera device 2 according to a second embodiment of the present invention. The camera device 2 includes a base 20 and a camera box 21. A reference numeral 29 denotes a switch of a power supply. Other reference numerals in FIG. 2-A are the same as those described above.

FIG. 2-B is a top view of the camera device 2. As is apparent from FIG. 2-B, the base 20 and the camera box 21 are sized so that the camera box 21 can be put in a U-shaped space 20′ of the base 20 with the slight gap 15 left therebetween. In addition, the pivot and bearing structures 16 are provided to the base 20 and the camera box 21 respectively so that the camera box 21 can be rotated by an angle (angle of depression or elevation) with respect to the U-shaped space 20′ of the base 20 to aim at a target to be picked up. Other reference numerals in FIG. 2-B are the same as those described above.

FIG. 2-C is a rear view of the camera device 2. A back surface of the camera device 2 is substantially a plane, and a reference numeral 22 denotes a strong magnet magnetically attachable on metal of iron family which is provided to the back surface. The whole camera device 2 can be attached to a surface made of metal of iron family in the tail portion of the automobile by use of the strong magnet 22 so that the camera device 2 is mounted and secured in a working position. A reference numeral 23 denotes a battery bin which is provided in the base 10 to store a battery as a power supply, and thus the camera device 2 can provide the power supply per se without the electrical plug 17 to be connected to the power supply in the first embodiment. Other reference numerals in FIG. 2-C are the same as those described above.

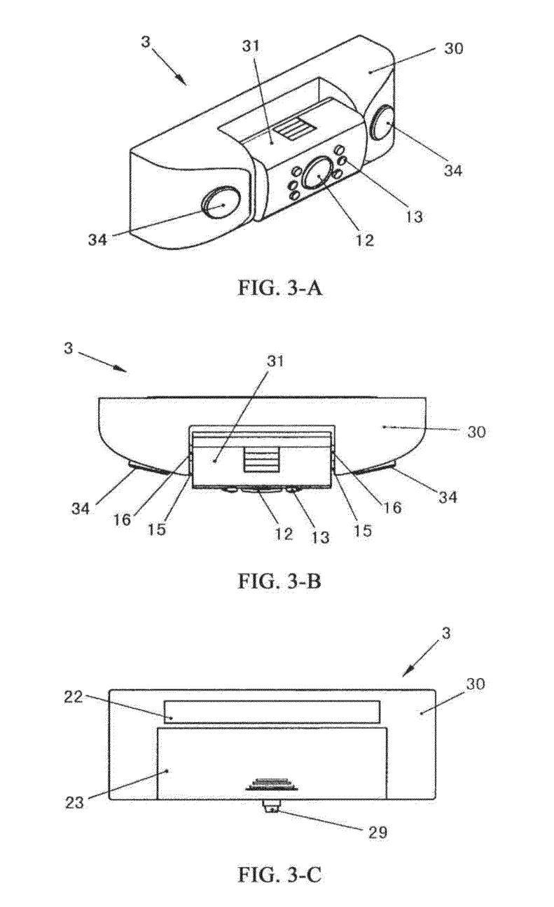

FIGS. 3-A, 3-B and 3-C are views showing a camera device according to a third embodiment of the present invention. FIG. 3-A is a front perspective view of the camera device 3, FIG. 3-B is a top view of the camera device 3, and FIG. 3-C is a rear view of the camera device 3. The camera device 3 includes a base 30 and a camera box 31.

A structure of the camera device 3 is almost the same as that of the camera device 2, and redundant explanation thereof is omitted here. The only one difference resides in a pair of supersonic range alerting probes 34 which are additionally provided to the base 30 of the camera device 3. The supersonic range alerting probes 34 are located on both sides of the camera device 31, and function to issue an alarm (sound, light and the like) according to an obstacle safe distance previously set, when the automobile is backed up (particularly when the automobile is backed up to park), so that safety is further improved. Other reference numerals in FIGS. 3-A, 3-B and 3-C are the same as those described above.

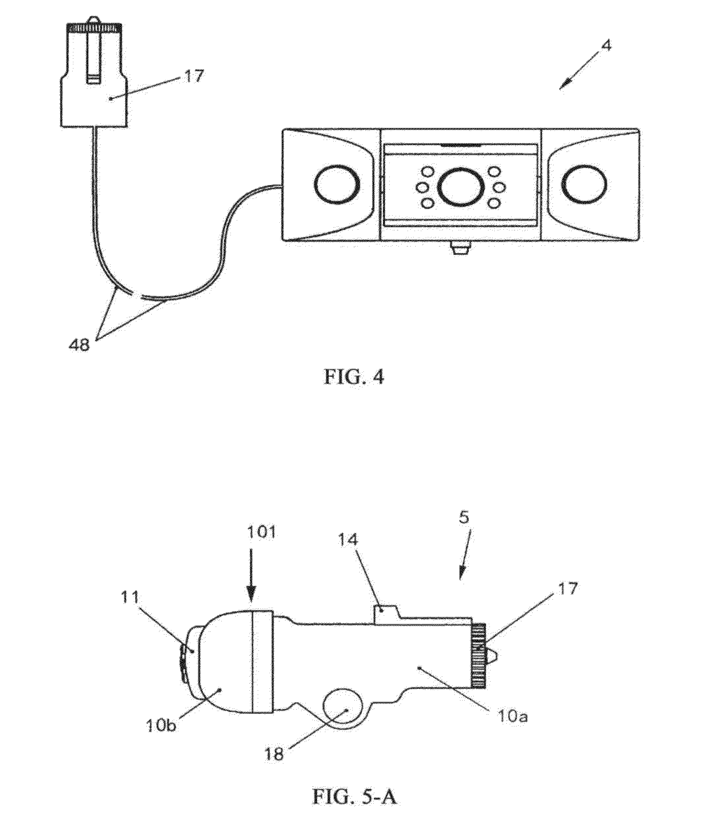

FIG. 4 shows a camera device 4 according to a fourth embodiment of the present invention. A main body portion of the camera device 4 is the same as that of the camera device 2 according to the second embodiment or that of the camera device 3 according to the third embodiment. The difference resides in that a power supply lead 48 is led out from the base of the camera device 4 and the other end of the power supply lead 48 is connected to the electrical plug 17. In this way, the camera device 4 not only can use the battery in its own battery bin as the power supply but also can use the power supply obtained through the electrical socket in the tail portion of the automobile via the electrical plug 17 so that it is more flexible and convenient.

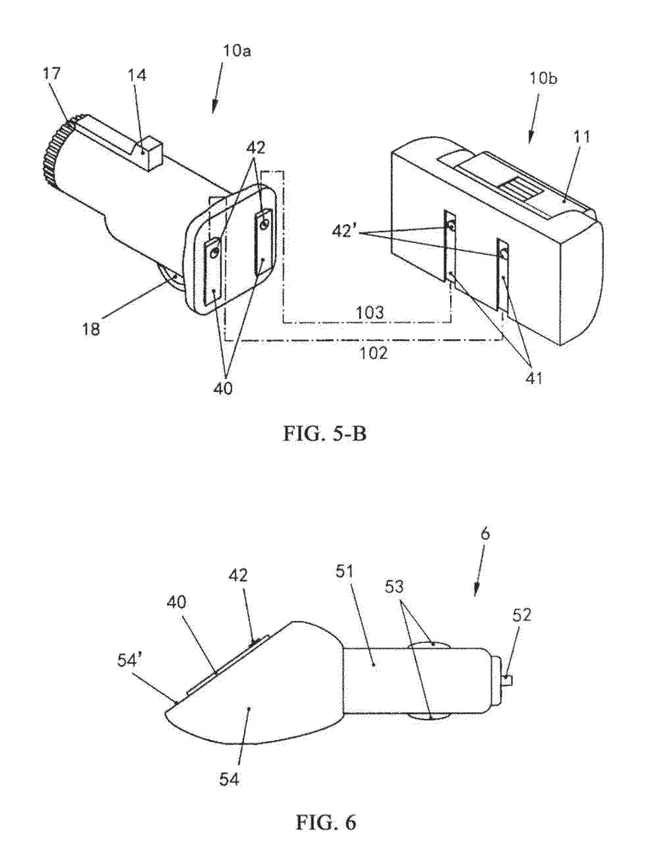

FIG. 5-A is an overall side view of a camera device 5 according to a fifth embodiment of the present invention. In this embodiment, the base is divided into an electrical plug portion and a camera portion which are connectable to and separatable from each other. The electrical plug portion and the camera portion of the base are denoted by reference numerals 10a and 10b respectively. A reference numeral 101 in FIG. 5-A indicates a seam position where the electrical plug portion 10a and the camera portion 10b can be separated or joined (FIG. 5-A shows a case in which both of them are joined together). In this embodiment, a battery bin (not shown in FIG. 5-A) for storing a battery as a power supply is also provided in the camera portion 10b of the base.

FIG. 5-B shows a case in which the camera device 5 according to the fifth embodiment of the present invention separates the electrical plug portion 10a from the camera portion 10b. A pair of protruding tabs 40 are provided on a back surface of the electrical plug portion 10a, and a pair of recessing grooves 41 are provided in a back surface of the camera portion 10b. The position, shape and size of the protruding tabs 40 are matchable with those of the recessing grooves 41 so that the pair of protruding tabs 40 on the back surface of the electrical plug portion 10a can be inserted into the pair of recessing grooves 41 in the back surface of the camera portion 10b as shown by dot dash lines 102 and 103 in FIG. 5-B. In this way, the electrical plug portion 10a and the camera portion 10b can be connected together, as is shown in FIG. 5-A. The structure of protruding tab and recessing groove can have various specific design forms. Electric contacts 42 and 42′ for current conducting and switching on are provided at the protruding tabs 40 and the recessing grooves 41 respectively, and when the electrical plug portion 10a and the camera portion 10b are connected together, the electric contacts 42 and 42′ switch a circuit on. As a matter of course, it is possible that recessing grooves are provided in the back surface of the electrical plug portion 10a and protruding tabs are provided on the back surface of the camera portion 10b (not shown in FIG. 5-B).

As shown in FIG. 6, in the embodiment, one electrical plug device 6 is additionally provided, and an electrical plug 51 which can be inserted into an electrical socket for a power supply of 12V-24V DC in the automobile so as to be connected to the power supply is provided on one end of the electrical plug device 6. The electrical plug 51 has an electric contact 52 (usually used as a positive pole) and an electric contact 53 (usually used as a negative pole). A recessing groove-protruding tab structure (herein, protruding tabs 40) which is matchable with the protruding tab-recessing groove structure of the camera portion 10b of the base is provided on a back surface 54′ of a main body portion 54 of the electrical plug device 6, and connectable electric contacts 42 are also provided on the back surface 54′. Other reference numerals in FIGS. 5-A, 5-B and 6 of the present embodiment are the same as those described above.

In an alternative of the embodiment, like the second embodiment, the strong magnet which is magnetically attachable on metal of iron family is provided to the back surface of the camera portion 10b of the base. The camera portion 10b of the base can be used as an integral camera device attached to a surface made of metal of iron family in the tail portion of the automobile by use of the strong magnet. This alternative is not shown in FIGS. 5-A, 5-B and 6.

The present embodiment offers more flexibility and convenience for the camera device of the present invention. When the electrical plug portion 10a and the camera portion 10b are joined together as shown in FIG. 5-A, they can be inserted into the electrical socket in the tail portion of the automobile, and when the automobile does not provide a power supply, the battery contained in the camera portion can be used as the power supply. When electrical plug portion 10a and the camera portion 10b are separated from each other as shown in FIG. 5-B, the camera portion 10b of the base and the electrical plug device 6 can be connected to each other to charge the battery in the camera portion 10b of the base by use of the electrical socket for the power supply of 12V-24V DC in the automobile, or the camera portion 10b provided with the strong magnet of the base can be used as an integral camera device attached to the surface made of metal of iron family in the tail portion of the automobile.

In the above embodiments, a transmission device which transmits an image signal picked up by the camera in a wireless manner is provided in the camera box 11, 21 or 31, or provided in the base 10, 10a, 10b, 20 or 30, so that a display screen device in the automobile receives the image signal in a wireless manner and displays the picked up image.

1. A camera device, wherein
the camera device includes a base and a camera box attached to the base, the camera device is adapted to be mounted outside a tail portion of an automobile so that a camera in the camera box faces rearward of the automobile,
the base has a U-shaped space, a distance between two sides of the U-shape is approximately equal to a length of the camera box so that the camera box is exactly laid within the U-shaped space,
pivot and bearing structures which enable the camera box to be rotated by an angle with respect to the U-shaped space of the base are provided at positions where each of both ends of the camera box adjoins to or connects with the U-shaped space,
an electrical plug which is matchable with an electrical socket in the tail portion of the automobile so as to be connected to a power supply is provided integrally with the base, and
a transmission device which transmits an image signal picked up by the camera in a wireless manner is provided in the camera box or the base so that a display screen device in the automobile receives the image signal in a wireless manner and displays the picked up image.

2. The camera device according to claim 1, wherein a fixing catch which matches with a spring closing cap of the electrical socket in the tail portion of the automobile is provided on the base.

3. The camera device according to claim 1, wherein a lock engaging ring to be connected to a theftproof lock is provided in the base.

4. The camera device according to claim 1, wherein semiconductor auxiliary light sources with the number of 2 to 12 are provided around the camera of the camera box.

5. The camera device according to claim 1, wherein a pair of supersonic range alerting probes are provided on both sides of the camera box on the base.

6. A camera device, wherein
the camera device includes a base and a camera box attached to the base, the camera device is adapted to be mounted outside a tail portion of an automobile so that a camera in the camera box faces rearward of the automobile,
the base has a U-shaped space, a distance between two sides of the U-shape is approximately equal to a length of the camera box so that the camera box is exactly laid within the U-shaped space,
pivot and bearing structures which enable the camera box to be rotated by an angle with respect to the U-shaped space of the base are provided at positions where each of both ends of the camera box adjoins to or connects with the U-shaped space,
a battery bin for storing a battery as a power supply is provided in the base, and a magnet which is magnetically attachable on metal of iron family is provided to a surface of the base, and
a transmission device which transmits an image signal picked up by the camera in a wireless manner is provided in the camera box or the base so that a display screen device in the automobile receives the image signal in a wireless manner and displays the picked up image.

7. The camera device according to claim 6, wherein a power supply lead is led out from the base, and an electrical plug which is matchable with an electrical socket in the tail portion of the automobile is provided on a distal end of the power supply lead.

8. The camera device according to claim 6, wherein a lock engaging ring to be connected to a theftproof lock is provided in the base.

9. The camera device according to claim 6, wherein semiconductor auxiliary light sources with the number of 2 to 12 are provided around the camera of the camera box.

10. The camera device according to claim 6, wherein a pair of supersonic range alerting probes are provided on both sides of the camera box on the base.

11. A camera device, wherein
the camera device includes a base and a camera box attached to the base, the camera device is adapted to be mounted outside a tail portion of an automobile so that a camera in the camera box faces rearward of the automobile,
the base is divided into an electrical plug portion and a camera portion which are connectable to and separatable from each other, two pair of protruding tab-recessing groove structures which are connectable to and separatable from each other are provided in the electrical plug portion and the camera portion respectively, and a pair of electric contacts which are connectable to each other are provided at respective positions of each pair of the protruding tab-recessing groove structures,
an electrical plug which is matchable with an electrical socket in the tail portion of the automobile so as to be connected to a power supply is provided integrally with the electrical plug portion of the base,
a battery bin for storing a battery as a power supply is provided in the camera portion of the base,
the base has a U-shaped space, a distance between two sides of the U-shape is approximately equal to a length of the camera box so that the camera box is exactly laid within the U-shaped space,
pivot and bearing structures which enable the camera box to be rotated by an angle with respect to the U-shaped space of the base is provided at positions where each of both ends of the camera box adjoins to or connects with the U-shaped space, and
a transmission device which transmits an image signal picked up by the camera in a wireless manner is provided in the camera box or the base so that a display screen device in the automobile receives the image signal in a wireless manner and displays the picked up image.

12. The camera device according to claim 11, wherein a magnet which is magnetically attachable on metal of iron family is also provided to a surface of the camera portion of the base.

13. The camera device according to claim 11, wherein a fixing catch which matches with a spring closing cap of the electrical socket in the tail portion of the automobile is provided on the electrical plug portion of the base.

14. The camera device according to claim 11, wherein a lock engaging ring to be connected to a theftproof lock is provided in the base.

15. The camera device according to claim 11, wherein semiconductor auxiliary light sources with the number of 2 to 12 are provided around the camera of the camera box.

16. The camera device according to claim 11, wherein a pair of supersonic range alerting probes are provided on both sides of the camera box on the base.

17. The camera device according to claim 11, wherein an electrical plug device which can be inserted into an electrical socket for a power supply of 12V-24V DC in the automobile so as to be connected to the power supply is additionally provided, the electrical plug device has a recessing groove-protruding tab structure which is matchable with the protruding tab-recessing groove structure of the camera portion of the base, and connectable electric contacts are provided in the recessing groove-protruding tab structure.
